(19) United States
(12) Patent Application Publication
(10) Pub. No.: US 2012/0319558 A1
(43) Pub. Date: Dec. 20, 2012

(54) ELECTRODE FOR DISCHARGE LAMP AND METHOD FOR MANUFACTURING SAME

(75) Inventors: Kouji Komata, Gyoda-shi (JP); Kazushi Tominaga, Gyoda-shi (JP); Hirokazu Harasawa, Gyoda-shi (JP); Kanae Hori, Gyoda-shi (JP)

(73) Assignee: IWASAKI ELECTRIC CO., LTD., Chuo-ku, Tokyo (JP)

(21) Appl. No.: 13/582,461

(22) PCT Filed: Feb. 21, 2011
(86) PCT No.: PCT/JP2011/054408

§ 371 Date: Sep. 6, 2012

(30) Foreign Application Priority Data
Apr. 2, 2010 (JP) 2010-086130

(51) Int. Cl. H01J 1/00; H01J 9/02

(52) U.S. Cl. 313/357; 445/49

(57) ABSTRACT

Disclosed is an arrangement for a cut type electrode, wherein the removal of a coil is prevented and the generation of gap between turns of a coil caused by repeatedly turning on and off of the lamp is suppressed. The electrode, which is for a discharge lamp, comprises: a core rod having a leading end portion for discharge formed by a cutting process; and a coil wound around the core rod in n-turns in a state exposing the leading end portion, wherein at least a first portion between a first turn and a turn adjacent to the first turn and a second portion between an n-th turn and a turn adjacent to the n-th turn are welded.

### TECHNICAL FIELD

The present invention relates to an electrode for discharge lamp and a method for manufacturing the same. More specifically, the present invention relates to a structure of a leading-end cut-type electrode for discharge lamp around which a coil is wound.

### BACKGROUND ART

Electrodes for discharge lamp are roughly classified into leading-end melted-type electrodes and leading-end cut-type electrodes. A leading-end melted-type electrode is an electrode made by winding a coil around a leading-end portion of a core rod and melting the leading-end portion of the core rod and a portion of the coil near the leading-end portion together to form a dome-shaped leading-end portion. A leading-end cut-type electrode is an electrode made by cutting a leading end into a tapered shape, winding a coil around a core rod and fixing the coil thereon with the leading-end portion being exposed. The present invention employs the latter, the cut-type electrode, in terms of easiness of welding and the like.

A coil to cover a core rod typically has a function of adjusting the temperature of an electrode. This determines ignition characteristics and heat radiation characteristics during discharge, and therefore determines discharge characteristics. It is necessary for the cut-type electrode to have a structure for preventing the coil from coming off the core rod, i.e., preventing the coming-off of the coil. Patent Documents 1 to 3 disclose examples of the cut-type electrode.

Patent Document 1 discloses an arrangement in which a core rod and a rear-end portion of a coil wound around the core rod are welded together and thereby the core rod and the coil are integrated to prevent the coming-off of the coil and prevent the coil from loosening rearward, i.e., springback.

Patent Document 2 discloses an arrangement in which a front-end portion and a rear-end portion of a lower-layer coil of coils wound around a core rod in layers are laser-welded to the core rod and thereby the coil is fixed on the core rod.

Patent Document 3 discloses an arrangement in which protrusions are provided to a core rod to regulate the position of a coil and position the coil.

### CITATION LIST

### Patent Documents

Patent Document 1: Japanese Patent No. 4325518

Patent Document 2: Japanese Patent Application Laid-Open No. 2001-527271

Patent Document 3: Japanese Patent No. 4188480

### SUMMARY OF INVENTION

### Technical Problem

The arrangements of Patent Documents 1 and 2 prevent the coming-off of a coil, but cannot suppress the misalignment of the coil itself. For example, with the arrangement of Patent Document 1, since repeated turn on and off (turning-on and off) of the discharge lamp causes the electrode to repeat thermal expansion/contraction and this causes forward extension of the coil, or due to other reasons, a gap is sometimes generated between turns of the coil. Meanwhile, although the positions of the two-end portions of the lower-layer coil are expected to be fixed, a gap is sometimes generated between turns of the coil even in the case of Patent Document 2 since repeated thermal expansion/contraction of the electrode due to turning-on and off loosens the arrayed upper-layer coil.

The generation of such gap between turns of the coil changes the thermal conduction characteristics of the coil from that of the original design. Thus, as the number of turning-on and off cumulatively increases, intended ignition characteristics or discharging characteristics may not be obtained. Moreover, the generation of the gap between turns of the coil also changes a starting position where discharge starts. Hence, the igniting operation may be also different from that intended in the original design.

Meanwhile, in order to fix the positions of the respective turns of the coil as in Patent Document 3, multiple protrusions are required according to the number of turns. This complicates the arrangement of the core rod and thus causes a problem of poor productivity.

Thus, the present invention has an objective to provide a cut-type electrode having an arrangement for preventing the coming-off of a coil and generation of a gap between turns of the coil due to repeated turning-on and off.

### Solution to Problem

A first aspect of the present invention is an electrode for discharge lamp comprising: a core rod (10) having a leading-end portion (11) for discharge formed by a cutting; and a coil (20) wound around the core rod in n-turns with the leading-end portion being exposed, in which at least a first portion (Fa) between a first turn and a turn adjacent to the first turn and a second portion (Fb) between an n-th turn and a turn adjacent to the n-th turn are welded.

A second aspect of the present invention is a discharge lamp including: a pair of electrodes (30) each comprising the electrode for discharge lamp according to the first aspect; and a bulb (40), in which the pair of electrodes for discharge lamp are arranged to face each other in the bulb.

A third aspect of the present invention is a method for manufacturing an electrode for discharge lamp including the processes of: preparing a core rod having a leading-end portion for discharge formed by a cutting; winding a coil around the core rod in n-turns with the leading-end portion being exposed; and welding at least a first portion between a first turn and a turn adjacent to the first turn and a second portion between an n-th turn and a turn adjacent to the n-th turn.

In each of the above aspects, the first portion and the second portion may be welded linearly. In this respect, a portion from the first portion to the second portion is welded continuously and substantially straight line in a longitudinal direction of the core rod.

### BRIEF DESCRIPTION OF DRAWINGS

FIG. 1 is a photograph showing an electrode for discharge lamp according to a first example of the present invention.

FIG. 2A is a view showing a modified example of the first example of the present invention.

FIG. 2B is a view showing a modified example of the first example of the present invention.

FIG. 3A is a photograph showing an electrode for discharge lamp according to a second example of the present invention.

FIG. 3B is a view showing the electrode for discharge lamp according to the second example of the present invention.

FIG. 4A is a view showing a modified example of the second example of the present invention.

FIG. 4B is a view showing a modified example of the second example of the present invention.

FIG. 5 is a view showing a discharge lamp of the present invention.

FIG. 6 is a flowchart showing a method for manufacturing the electrode for discharge lamp of the present invention.

FIG. 7A is a view for supplemental description of the present invention.

FIG. 7B is a view for supplemental description of the present invention.

### DESCRIPTION OF EMBODIMENTS

### Example 1

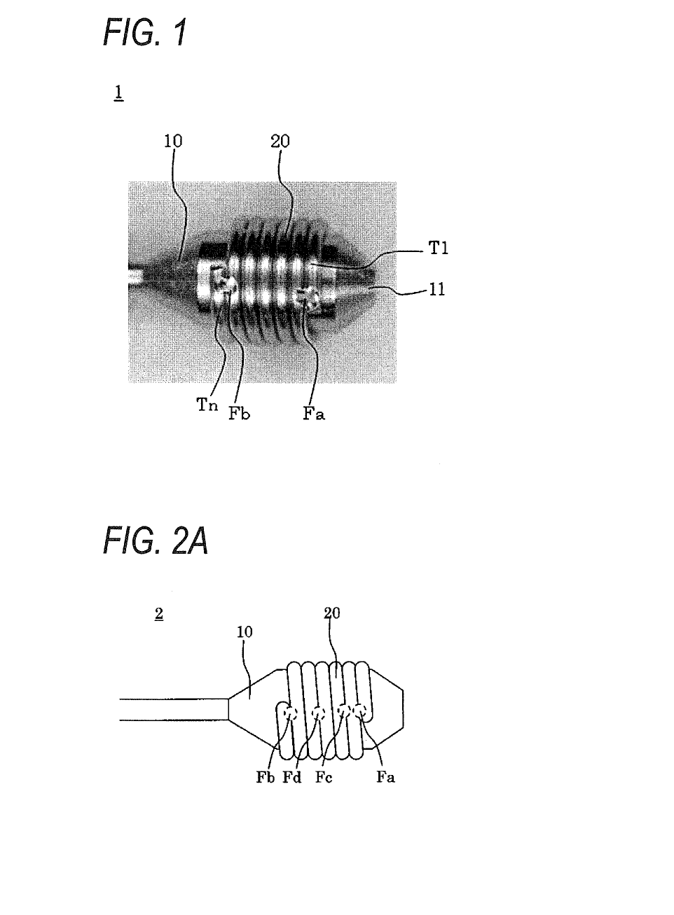

FIG. 1 shows an electrode for discharge lamp 1 according to a first example of the present invention. The electrode for discharge lamp 1 comprises: a core rod 10 that has a leading-end portion 11 for discharge formed by a cutting; and a coil 20 that is wound around the core rod in n-turns with the leading-end portion 11 being exposed. In this example, in the coil 20, at least a first portion Fa between a first turn Ti and a turn T2 adjacent to the first turn Ti and a second portion Fb between an n-th turn Tn and a turn Tn-1 adjacent to the n-th turn Tn are welded. The welding is carried out by laser beam welding, TIG welding, electric resistance welding, or the like. Note that the core rod 10 and the coil 20 are not welded.

The above welding at the two portions defines diameters of the coil 20 at a leading-end-diameter portion (from the first turn Ti to the second turn T2) and at a rear-end-diameter portion (from the (n-1)-th turn Tn-1 to the n-th turn Tn). This prevents the coil 20 from loosening, so that the coming-off of the coil can be prevented. In addition, the above welding fixes shapes of the coil 20 at the leading-end-diameter portion and at the rear-end-diameter portion. This ensures these portions to be held on the core rod 10 and prevents the coil 20 from being shifted in an electrode axis direction, which can prevent generation of a gap between turns of the coil.

Moreover, in contrast to Patent Documents 1 and 2 in both of which welding is applied between a coil and a core rod of different materials (of greatly different heat capacities even if they are of the same material), welding is applied between turns of the coil, which are of the same material, in this example, which allows for good welding workability.

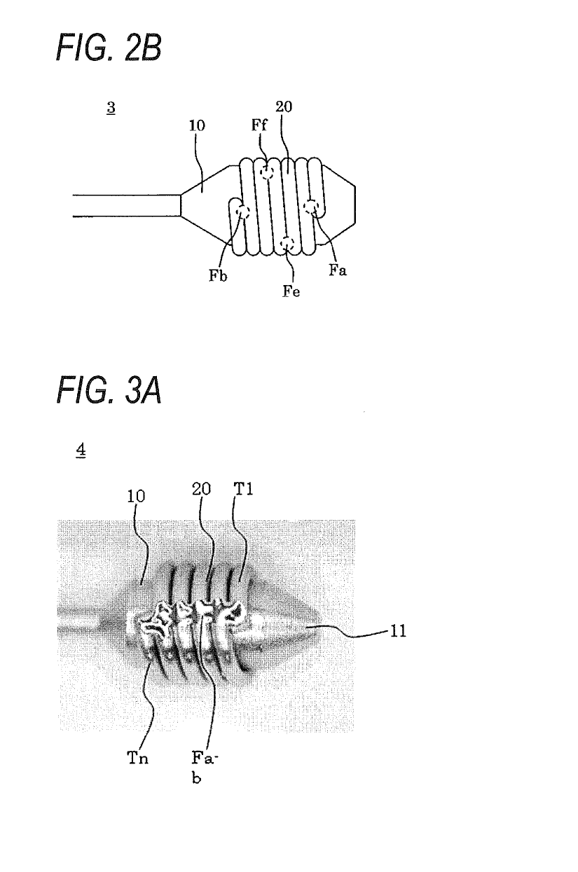

FIGS. 2A and 2B further show electrodes 2 and 3 that are the modified examples of this example. In each of the electrodes 2 and 3, intermediate welding portions Fc, Fd, Fe, and Ff are provided between the welding portions Fa and Fb and thereby the number of welding portions is increased in order to strengthen the effect of preventing the coming-off of the coil and generation of the gap between turns of the coil. In the electrode 2, the welding portions Fa, Fb, Fc, and Fd face a single direction, while, in FIG. 2B, the welding portions Fa, Fb, Fe, and Ff are distributed in multiple directions with respect to an electrode axis. Regarding the electrode 2, since welding can be made on the electrode 2 in a single direction (e.g., a laser beam can be radiated in a single direction), a welding operation can be carried out efficiently. Regarding the electrode 3, since the welding portions are distributed on the electrode 3, the strengthening effect can be obtained with few welding portions. Note that, although the two intermediate welding portions are shown in each of FIGS. 2A and 2B, any number of intermediate welding portions may be employed.

### Example 2

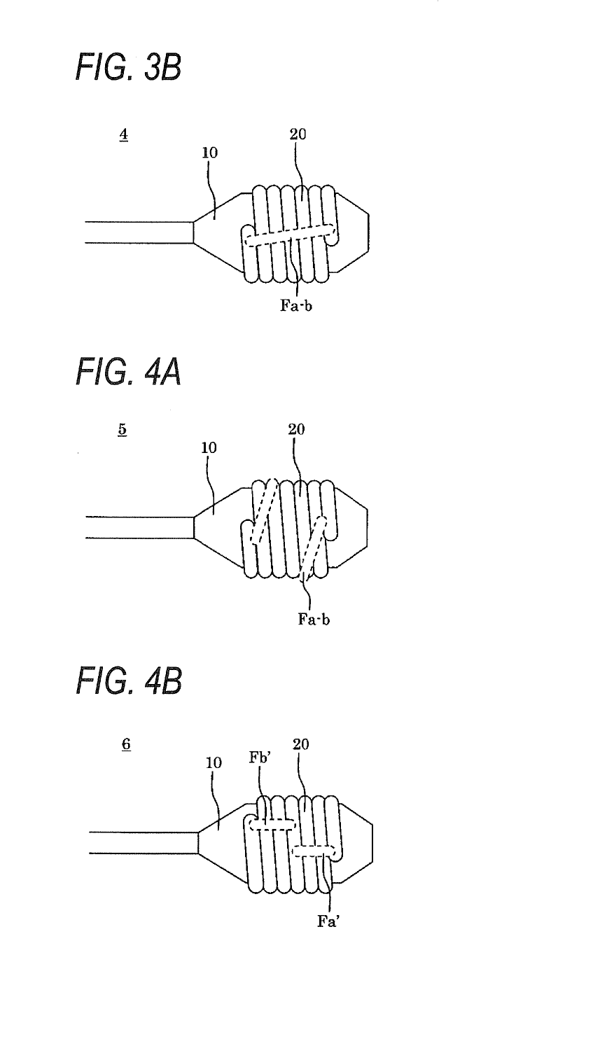

While the welding portions in the form of dots are illustrated in the first example, linear welding portions are illustrated in a second example. FIG. 3A shows a photograph of an electrode 4 according to the second example of the present invention, and FIG. 3B shows illustration thereof. In this example, welding is performed to form a welding portion Fa-b that extends continuously and substantially straight line in a longitudinal direction of a core rod 10 from a portion Fa between a first turn T1 and a turn T2 adjacent to the first turn T1 to a portion Fb between an n-th turn Tn and a turn Tn-1 adjacent to the n-th turn. While the welding portion Fa-b is preferably continuous, a partially-disconnected welding portion may also be possible. In this example as well, the welding is carried out by the laser beam welding, TIG welding, electric resistance welding, or the like, and the core rod 10 and the coil 20 are not welded.

The above welding portion Fa-b defines diameters of the coil 20 at the respective turns. This prevents the coil 20 from loosening, so that the coming-off of the coil can be prevented. In addition, the above welding portion fixes shapes of the coil 20 at the respective turns. This ensures these portions to be held on the core rod 10 and prevents the coil 20 from being shifted in an axis direction, which can prevent generation of a gap between turns of the coil.

Moreover, since integrating the turns, this example exhibits a stronger effect of preventing the coming-off of the coil and generation of the gap between turns of the coil than the case of FIG. 1 of Example 1. Further, this example does not require high positioning accuracy in welding as the case of FIG. 2A or FIG. 2B and thus allows for easy welding. Furthermore, since making the welding portion in the form of a straight line, this example requires minimum welding and thus allows for good productivity.

FIG. 4A shows an electrode 5 according to a modified example of this example. While the welding portion Fa-b is made by the welding in the form of a straight line on substantially a single surface in the electrode 4, a welding portion Fa-b is welded spirally in the electrode 5. In this way, since the electrode 5 has a wide welding range, the effect of preventing the coming-off of the coil and generation of the gap between turns of the coil is further enhanced. Further, since the electrode 5 has welding points distributed in all directions with respect to the electrode axis, the physical profile of the electrode can be made symmetric with respect to the electrode axis.

FIG. 4B shows an electrode 6 according to a modified example of this example. While the welding portion Fa-b is formed of one line in each of the above electrodes 4 and 5, a welding portion is formed of multiple lines in the electrode 6. As shown in the drawing, one welding portion Fa′ includes the welding portion Fa, whereas the other welding portion Fb′ includes the welding portion Fb. Moreover, the welding portions extend in parallel with the electrode axis. This arrangement makes it possible to weld portions near end portions 21 and 22 of the coil 20 as well as to minimize a welding length. Further, this arrangement eliminates the need to perform welding while a laser and the electrode 6 are rotated relative to each other about the electrode axis (i.e., eliminates the need to radiate a laser beam while the electrode 6 is rotated about the axis, or to radiate a laser beam while the laser is rotated with respect to the electrode 6) at one welding operation when laser beam welding is performed for example, which facilitates manufacturing.

Note that, although the lengths of the welding portions Fa′ and Fb′ are set so that these portions do not overlap in their length direction in order to minimize a welding length, the lengths of the welding portions may be larger than those illustrated. For example, the portion Fa′ may reach the n-th turn Tn, or the portion Fb′ may reach the first turn T1. In other words, multiple linear welding portions shown in FIG. 3 may be provided.

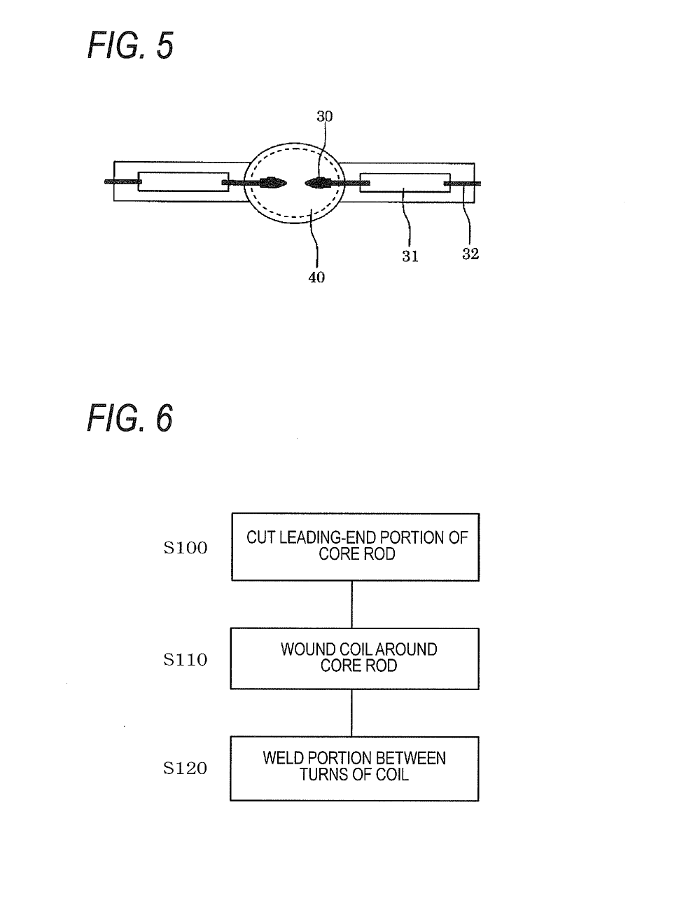

FIG. 5 shows a discharge lamp using a pair of electrodes 30 according to the above examples. The discharge lamp includes: a bulb 40 made of quartz glass or the like; and the pair of electrodes 30 arranged to face each other in the bulb 40. Any of the electrodes 1 to 6 may be used for the pair of electrodes 30. The bulb 40 includes a molybdenum foil 31 and a lead 32 that are connected to each electrode 30. Note that at least mercury and inert gas are enclosed in the bulb 40; and that the electrodes according to the present invention are particularly suitable for high pressure discharge lamps.

The above arrangement makes it possible to achieve a discharge lamp capable of maintaining ignition characteristics and discharge characteristics intended in the original design even when the number of turning-on and off is accumulated.

FIG. 6 is a flowchart showing a method for manufacturing an electrode for discharge lamp according to the present invention.

In Step S100, a core rod 10, which has a leading-end portion 11 for discharge formed by a cutting, is prepared.

In Step S110, a coil 20 is wound around the core rod 10 in n-turns with the leading-end portion 11 being exposed.

In Step S120, at least a first portion Fa between a first turn T1 and a turn T2 adjacent to the first turn T1 and a second portion Fb between an n-th turn Tn and a turn Tn-1 adjacent to the n-th turn Tn are welded. In this respect, as described above, other welding portions may be provided between the first portion Fa and the second portion Fb; alternatively, the first portion Fa and the second portion Fb may be welded linearly.

The above manufacturing method makes it possible to manufacture, with high productivity, the electrode that can prevent the coming-off of the coil and generation of a gap between turns of the coil due to repeated turning-on and off.

Although the most preferred examples of the present invention have been described above, the present invention can be modified as follows without departing from the concept of the invention.

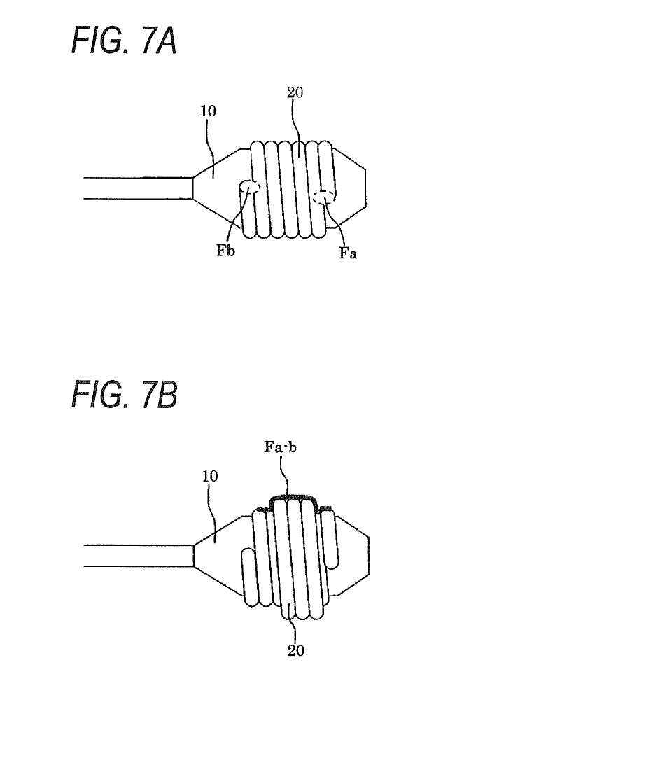

(1) In each of the above examples, as shown in FIG. 7A, the welding portions Fa and Fb may include an end portion of the first turn T1 and an end portion of the n-th turn Tn, respectively. Thereby, undesired discharge from the end portions of the coil can be prevented.

(2) Although the single-layered coil has been shown in the above examples, the effect of the present invention can also be achieved by use of a multi-layered coil by welding the coil continuously from its lower layer to its upper layer, as shown in FIG. 7B.

(3) Although, in the above examples, the winding direction of the coil 20 is in such a way that the electrode-distal-side of the coil is the first turn (the electrode-proximal-side of the coil is the n-th turn), the electrode-proximal-side of the coil may be the first turn (the electrode-distal-side of the coil may be the n-th turn). Further, the welding of the welding portions Fa, Fb, Fc, Fd, Fe, and Ff can be performed in any order, and the welding of the welding portion Fa-b, Fa′, or Pb′ can be performed in any direction.

### REFERENCE NUMERALS

1-6 electrode
10 core rod
11 leading-end portion
20 coil
30 electrode
40 bulb
Fa, Pb, Fc, Fd, Fe, Ff, Fa-b, Fa′, Pb′ welding portion

1. An electrode for discharge lamp comprising:
a core rod having a leading-end portion for discharge formed by a cutting; and
a coil wound around the core rod in n-turns with the leading-end portion being exposed,
wherein at least a first portion between a first turn and a turn adjacent to the first turn and a second portion between an n-th turn and a turn adjacent to the n-th turn are welded.

2. The electrode for discharge lamp according to claim 1, wherein a portion between the first portion and the second portion is welded linearly.

3. The electrode for discharge lamp according to claim 2, wherein a portion from the first portion to the second portion is welded continuously and substantially straight line in a longitudinal direction of the core rod.

4. A discharge lamp comprising: a pair of electrodes each comprising the electrode for discharge lamp according to claim 1; and a bulb, wherein the pair of electrodes for discharge lamp are arranged to face each other in the bulb.

5. A method for manufacturing an electrode for discharge lamp comprising the processes of:
preparing a core rod having a leading-end portion for discharge formed by a cutting;
winding a coil around the core rod in n-turns with the leading-end portion being exposed; and
welding at least a first portion between a first turn and a turn adjacent to the first turn and a second portion between an n-th turn and a turn adjacent to the n-th turn.

6. The manufacturing method according to claim 5, wherein the welding process includes a process of welding a portion between the first portion and the second portion linearly.

7. The manufacturing method according to claim 5, wherein the welding process includes a process of welding a portion from the first portion to the second portion continuously and substantially straight line in a longitudinal direction of the core rod.
